(19) United States
(12) Patent Application Publication
(10) Pub. No.: US 2010/0088152 A1
(43) Pub. Date: Apr. 8, 2010

(54) PREDICTING USER RESPONSE TO ADVERTISEMENTS

(76) Inventor: Dominic Bennett, Los Altos, CA (US)

Correspondence Address: GLENN PATENT GROUP, 3475 EDISON WAY, SUITE L, MENLO PARK, CA, 94025, US

(21) Appl. No.: 12/410,400

(22) Filed: Mar. 24, 2009

Related U.S. Application Data
(60) Provisional application No. 61/102,317, filed on Oct. 2, 2008.

(51) Int. Cl. G06Q 30/00; G06Q 99/00

(52) U.S. Cl. 705/10; 705/30; 705/26; 705/14.53

(57) ABSTRACT

A system for predicting user responses to advertisements comprises a data collection component, a segmentation component, a modeling component, a rule building component, and an ad scoring component. The data collection component receives data from cookies stored on each client and from other sources. The segmentation component organizes the data according to segments. The modeling component groups users according to segments and compares a user's actions to the models to predicts the user's future responses. The rule building component generates an ad campaign comprised of rules. The model or the rules are compared to a plurality of rules to generate a score. The ad with the highest combination of a score and a bid is displayed on the client.

### CROSS REFERENCE TO RELATED APPLICATIONS

This patent application claims the benefit of U.S. provisional patent application Ser. No. 61/102,317, Turn Segment (Rule) Builder Requirements, filed Oct. 2, 2008, the entirety of which is incorporated herein by this reference thereto.

### BACKGROUND OF THE INVENTION

1. Technical Field

This invention relates generally to the field of advertising. More specifically, this invention relates to predicting user response to advertisements.

2. Description of the Related Art

An advertisement creative describes any type of advertising content or image that advertises a product or service. Advertisements displayed on a web page are called impressions. FIG. 1 (prior art) illustrates one version of an ad-delivery system. A user employs a client 100, e.g. a computer to select a browser to load Web pages. The browser requests the Web pages from the publisher 20. The publisher 20 sends out an ad call in the form of an HTTP request to the ad network 30, which is populated with ads from the advertiser 10. The ad network 30 sends an ad to the publisher 20, which provides a web page and impression to the client 100.

The payment model for displaying impressions can be a flat fee, or more likely, a combination of a fee for displaying the impression and a fee for any instance where a user clicks on the advertisement, i.e. a click-through. Some payment models even include a conversion fee. See, for example, Google® U.S. Publication Number 2008/0103887. A conversion occurs when a user both clicks an advertisement and purchases either the product or service being advertised.

Typically, different advertisers bid for the same ad space. Because a user is more likely to click on a targeted impression, publishers have developed a variety of ways to personalize the impressions. Google®, for example, sells ad spaces that are paired with keywords entered into Google®'s search engine. The pairing results in a higher click-through rate. For example, if a user types “bird seed” into Google®'s search engine, ads relating to the sale of bird seed are served.

This method of pairing ad space with search terms, furthermore, is especially advantageous for companies that sell specialized products because the ad space is cheaper than for popular terms, e.g. “car,” but the click-through rate is much higher because it is more likely that the user is looking to purchase that specific item. For example, people who own parrots frequently buy foraging toys to keep the parrots entertained. When a user enters “foraging toys” into the Google® search engine, only a few sponsored links appear with the search results because the term is rare. However, a user looking for these toys is much more likely to click on one of the links than a user that employs “car” as a search term.

The drawback to these methods is that although the advertisements are targeted, they only reflect one dimension of a user. Google® developed a more detailed mechanism for personalizing search results. See, for example, U.S. Publication Number 2005/0240580. In this approach, the server orders search results for a user according to information gleaned from the user's Internet activity, e.g. previous search queries, uniform resource locators (URLs) identified by the user, anchor text of the identified URLs, general information about the identified documents, the user's activities on the identified documents, sampled content from the identified documents, category information about the identified documents, the user's personal information, and the user's browsing patterns. This approach is limited, however, because it only tracks a user's activities when the user is logged-in to Google®. Furthermore, because the system is predicting user behavior based on that user's previous behavior, the prediction is only useful for predicting that the future behavior conforms to previous behavior. This method cannot make predictions about new areas for which the user develops an interest.

### SUMMARY OF THE INVENTION

In one embodiment of the invention, user data is collected from a variety of sources, e.g. Internet activity. The data is compiled and segmented according to subject matter. The segments are used either in a behavioral model or organized according to pre-defined rule segments. User data is scored against the behavioral model or rule segments in real-time. The closest matching advertisements are served on the web page. The user's reaction to the advertisements is recorded by the cookie and transmitted to the server to further refine the segments.

### BRIEF DESCRIPTION OF THE DRAWINGS

FIG. 1 is a block diagram that illustrates a prior art system for serving ads;

FIG. 2 is a block diagram that illustrates a system for serving ads according to one embodiment of the invention;

FIG. 3A is an example of a client according to one embodiment of the invention;

FIG. 3B is an illustration of a distributed server environment according to one embodiment of the invention;

FIG. 4 is a block diagram that illustrates a system for receiving information and matching advertisements with users according to one embodiment of the invention;

FIG. 5 is an example of a user interface according to one embodiment of the invention;

FIG. 6 is an illustration of a user interface for defining rules according to another embodiment of the invention;

FIG. 7 is a flow diagram that illustrates steps for generating segments according to one embodiment of the invention; and

FIG. 8 is a flow diagram that illustrates the steps for displaying an advertisement according to one embodiment of the invention.

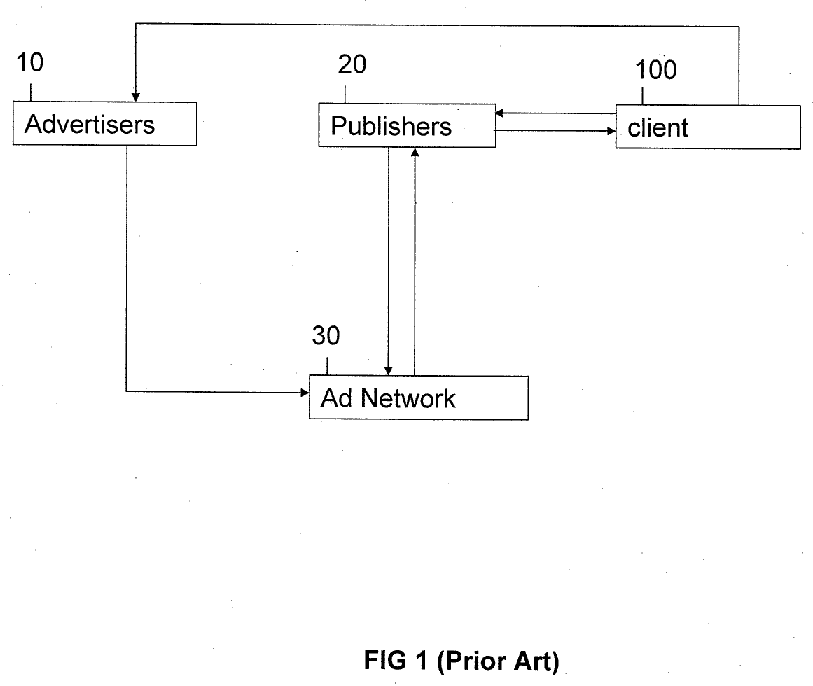

### DETAILED DESCRIPTION OF THE INVENTION

In one embodiment, the invention comprises a method and/or an apparatus for collecting user data, creating behavioral segments, scoring ads according to the segments, serving targeted ads to users, and recording user responses to further refine the behavioral segments.

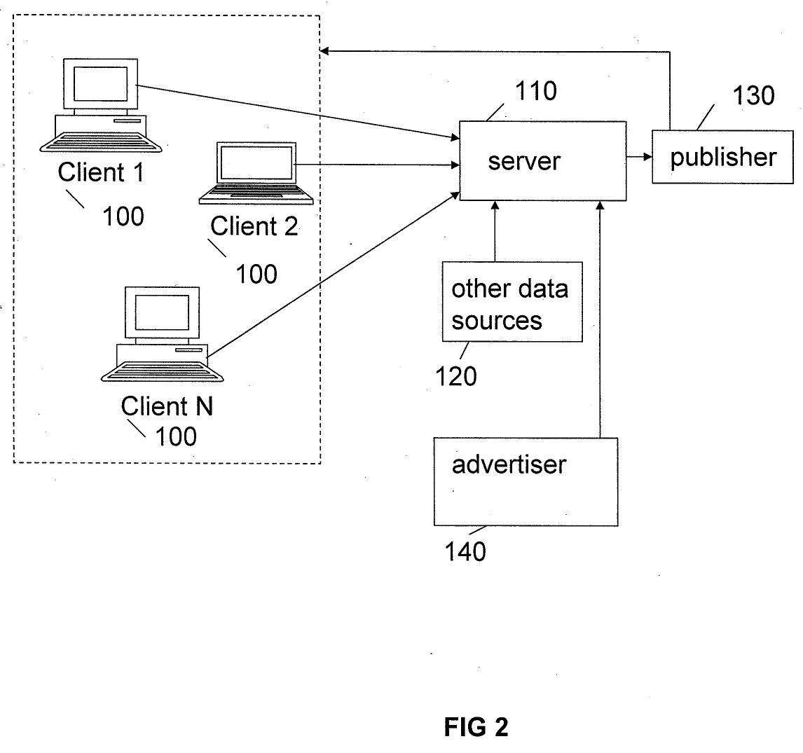

FIG. 2 is an example of the system according to one embodiment of the invention where the clients 100 provide data to a server 110, which uses the data to predict user response to advertisements provided by advertisers 140 and serves the best impression to the publisher 130 for delivery to the client 100.

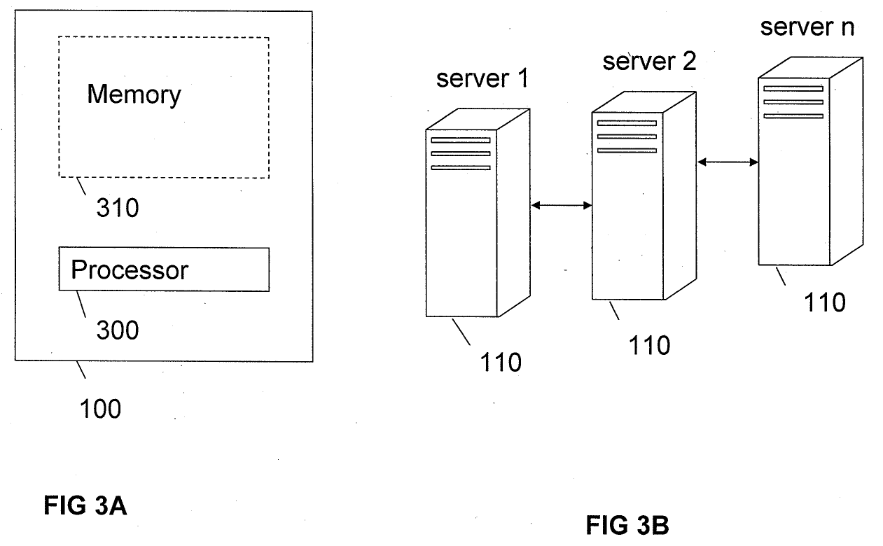

FIG. 3A is an example of a client 100 according to one embodiment of the invention. The client is a computing platform configured to act as a client device, e.g. a computer, a digital media player, a personal digital assistant, a cellular telephone, Internet applications, etc. The client 100 may include a number of external or internal devices, e.g. a mouse, a keyboard, a display device, etc.

The client 100 includes a computer-readable medium 310, e.g. random access memory (RAM), coupled to a processor 300. The processor 300 execute s computer-executable program code stored in memory 310. Other embodiments of a computer-readable medium 310 include, but are not limited to, an electronic, optical, magnetic, or other storage or transmission device capable of coupling to a processor, e.g. flash drive, CD-ROM, DVD, magnetic disk, memory chip, ROM, etc.

In one embodiment, the system includes multiple client devices 100 that communicate with a server 110 over a network. The network comprises the Internet. In another embodiment, the network is a local area network (LAN), a wide area network (WAN), a home network, etc. In one embodiment, the network is implemented via wireless connections. FIG. 3B is an example of a distributed datastorage system according to one embodiment of the invention.

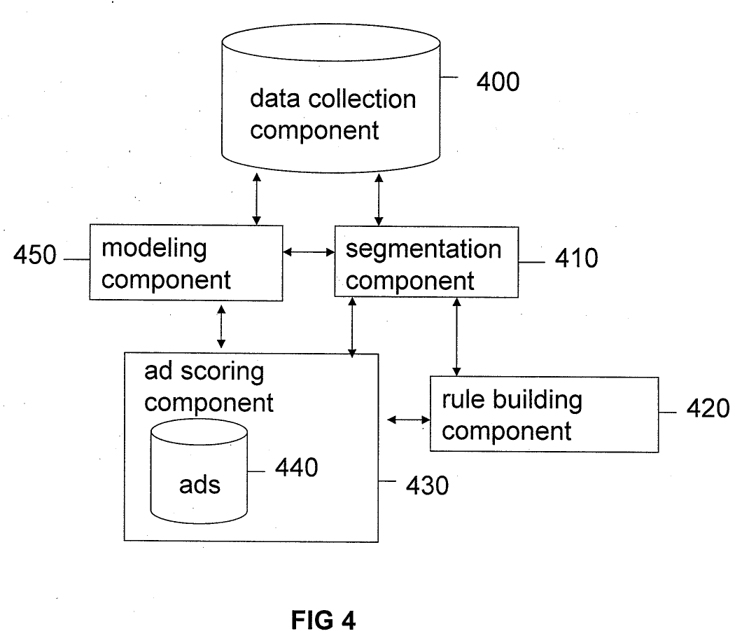

FIG. 4 is a block diagram of the components used to collect data, generate segments, generate rules, and score ads according to one embodiment of the invention.

Data Collection

The Website host installs a cookie on the client 100 that tracks a user's behavior on that host's Website, e.g. eBay can collect data for each user. The cookie is associated with a specific ISP address. As a result, when different hosts install cookies on the same client 100, the data is reconciled according to the ISP address once the data is compiled. In one embodiment, the cookie records user profile information from the website, e.g. age, location, income, educational status, job category, gender, etc. The cookie receives data from a Java script that runs on the client 100. The Java script is displayed as a one by one pixel on the client's 100 display.

In one embodiment, the cookie sends data directly to the server 110 that contains the data collection component 400. In another embodiment, the cookie sends data to a third-party server, e.g. the distributed datastore provided by Akamai of Cambridge, Mass., which transmits the information to the server 110. A third-party server insulates the rest of the system from being bombarded with data from the multiplicity of clients 100. Other advantages of using a third-party server will be apparent to a person of ordinary skill in the art.

The cookie collects data for two different groups: for advertisers 140 and for the data collection component 400 stored on the server side profile 110.

Data collection for advertisers 140 is triggered by a beacon that is embedded in the ad space. The beacon responds to a pre-determined rule. For example, using FIG. 2 as a reference, the advertiser 140, a car dealership in Mountain View, Calif., requests a notification each time a user enters search terms for any type of vehicle in any town in the counties of San Mateo and Santa Clara, Calif. Client N 100 searches for car dealerships in Palo Alto, Calif. As a result, the cookie sends a beacon containing this information to the server 110, which notifies the advertiser 140. The car dealership can directly target the user and because the data is so specific, there is a high likelihood that the user responds positively to any advertisements from the car dealership.

Data is stored in the data collection component 400. In one embodiment, the cookie records the category and event of each website visited by the user. The category refers to the source and type of website or search terms, e.g. car. The categories are segmented into more precise categories to encompass both the highly specific and the general. For example, Range Rovers is a specific example of a sport utility vehicle (SUV), which is a type of car. The event refers to an action taken by the user. For example, when the user visits a website advertising cars, the cookie records whether the user browsed cars, bought a car, bid on a car, searched for cars, etc.

In another embodiment, the cookie records the frequency of a user's visits and the frequency of events, e.g. the number of times a user searches for a Range Rover. The frequency can be characterized three ways: velocity, intensity, and persistence. Velocity refers to the rate at which a user visits a web page. For example, a user may visit a car website infrequently when he's considering buying a car and then more frequently when he's ready to purchase. That behavior is characterized as an increasing velocity. Intensity refers to how many times a user visits the website and tracks the images that the user views while using the website. Persistence measures whether the website is regularly visited by the user, e.g. eBay, Amazon, a favorite blog or whether the website was a one-time occurrence.

The cookie collects other pieces of information that are useful for categorizing user behavior. For example, each website that the user visits is tagged with a description, e.g. financial section of the New York Times. The cookie collects these tags. In addition, the cookie collects the browser speed because users with higher browser speeds are more likely to be earlier adaptors of technology.

This information is stored on the cookie and transmitted to the server side profile 110. The cookie can only store 4K of information. The cookie transmits this information to the server side profile 110 in real time, but because the cookie can be used as a back-up data storage device for determining which ad to serve to a user, the cookie must be kept relevant. Thus, the cookie continually discards the least valuable data elements. The value of the data is determined by frequency and time. Thus, if a user visits the NY Times daily, this information is kept on the cookie. However, if the user visited the Washington Post only once in the last month, that information is discarded.

Another source for information is proprietary data that is particular to a party and is only used to generate behavior predictions for that party. For example, a cell phone manufacturer installs a cookie on a user's machine when the user visits the manufacturer's website. The cookie transmits data about the user's activities while on the website, e.g. searching, completion of a registration form, etc. This data is important for gauging the user's level of interest, e.g. researching cell phones, intending to purchase a cell phone, already owns a cell phone, etc.

The information is used, along with other segmented data such as the user's activities on Amazon® to determine what type of ads to serve to the user while the user is on the manufacturer's website. For example, if it is clear that the user is about to make a purchase of a cell phone, the ad can offer a 10% discount. Furthermore, because the compiled data may include demographic information, previous purchases from other websites, etc. the behavior prediction can be even more specific for the user and predict down to the dollar how much the user is likely to pay for a cell phone. Because information gleaned from the cell phone manufacturer website is proprietary, it is kept separate from the rest of the information and is not sold to competitors.

Lastly, the data collection component 400 stores response data to advertisements selected by the ad scoring component 430. The response data includes the type of response, e.g. impression, click, and purchase and transformations associated with the response, i.e. time between impressions, time between clicks, and frequency of purchases.

In one embodiment of the invention, the server side profile 110 is a distributed data environment where multiple servers capture the data from cookies. FIG. 3B is an illustration of a distributed data environment. In another embodiment, the cookies are captured by only one server 110. The server 110 comprises computer hardware dedicated to functioning as a server 110. Alternatively, the server 110 is a software program stored on a computer for managing data.

In one embodiment, the server side profile 110 receives data from cookies, user profiles, and other sources 120. The other sources 120 include information that is not collected via the Internet. In one embodiment, other sources include information about purchases made through catalogs that are organized according to demographics, telemarketing information, etc.

Segmentation

The data collection component 400 transmits the data to the segmentation component 410 for segmentation. In one embodiment, the data is segmented according to four categories: demographics, contextual, integrated user profile, and historical data. Demographic data includes the location of the user, age, race, income, educational attainment, employment status, etc.

The subject matter searched by users is categorized using a data tree structure. In a data tree, the subject matter becomes more subdivided as the tree branches until the subject matter can no longer be divided any further, at which point the subject matter is referred to as a leaf node. For example, if a user is searching for a specific kind of watch, the categories may proceed from the following: jewelry and watches→watches→wristwatches→military watches→Czech military watches. Other methods of organizing data will be obvious to a person of ordinary skill in the art.

Behavioral Modeling

In one embodiment, the system includes behavior modeling for predicting a user's actions. The modeling component 450 groups segmented behaviors of multiple users together. For example, one group includes people that are interested in Czech military watches. Depending on the behavioral model, this “interest” can be defined as people who purchased Czech military watches, people who searched for those terms, people that purchase military watches, etc. The model also takes into account user frequency, i.e. velocity, intensity, and persistence.

The modeling component 450 makes associations between groups of users and the categories of interest. For example, people interested in Czech military watches may also be interested in typewriters or antique cars. People interested in buying designer purses may be interested in purchasing fashionable clothing or new televisions. In one embodiment, these categories are correlated using regression analysis.

Once the models are complete, users are compared to the models using real-time data to predict the user's similarity to user groups and, as a result, the user's likelihood of being interested in certain categories. For example, a user that purchased a laptop designed in the last year is grouped with other laptop purchasers. Those purchasers frequently purchased plasma televisions. Thus, the user being compared to the groups is likely to purchase a plasma television as well. As a result, the system uses cross-marketing to target a larger number of users while maintaining a high likelihood of success.

The user's behavior prediction is modeled in real time. The modeling component 450 queries the data collection component 400 for the user's data to predict the user's future actions. If the modeling component 450 is unavailable, the modeling component 450 queries the cookie, which provides up to 4k of the user's previous activities.

Ad Scoring

The prediction of a user's behavior is used by the ad scoring component 430 to predict the user's reaction to impressions for different categories. For example, in the above example, the user is likely to click on ads for laptops, but is not likely to click on ads for window treatments. The ad scoring component 430 assigns a score that represents the likelihood of a positive response to an ad. If an advertiser provides multiple ads, each ad is scored according to a segment and the ads are prioritized according to the highest score.

Matching is a function of the ad score and an advertiser's bid. For example, in one embodiment the scale for the score is between 0 and 1. Advertiser A has a score of 0.3, meaning that there is a low correlation between the segment and the advertisement, but the advertiser is willing to pay $1.00 for each impression served. Advertiser B has score of 0.9, but is only willing to pay $0.50 for each impression served. The score is multiplied by the bid, i.e. Advertiser A=0.3 and Advertiser B=0.5. Thus, even though Advertiser B is paying less for the ad, Advertiser B's ad is served because it is much more likely to result in a click through.

The publisher typically charges both for displaying the ad and for additional actions, e.g. click-through, conversion, etc. Thus, in the above example, even though the publisher receives less money for displaying the impression, the publisher makes more money because the user is more likely to click on the ad.

Once an ad is selected, a log file is generated. The log file identifies the ad, a full data profile, and a full segment membership at the time of the ad call. The log file is stored as part of the cookie and is transmitted to the server 110.

The ads are retrieved from an ad database 440 and transmitted to the publisher 130. The ad database 440 can be stored on the server 110 or provided by an advertiser 140. The ads are sent to the publisher for insertion into a web page space.

Rule Building

In another embodiment, a rule building component 420 generates rules for serving ads. Multiple rules can be used by the same segment by connecting rules using Boolean operators, i.e. and, or, not, etc. The rules can be part of a nested query, i.e. subqueries are defined by using parentheses. Rule combinations are associated with a unique segment identification (ID) and a user-generated segment description. A graphical user interface (GUI) is displayed for building rule combinations.

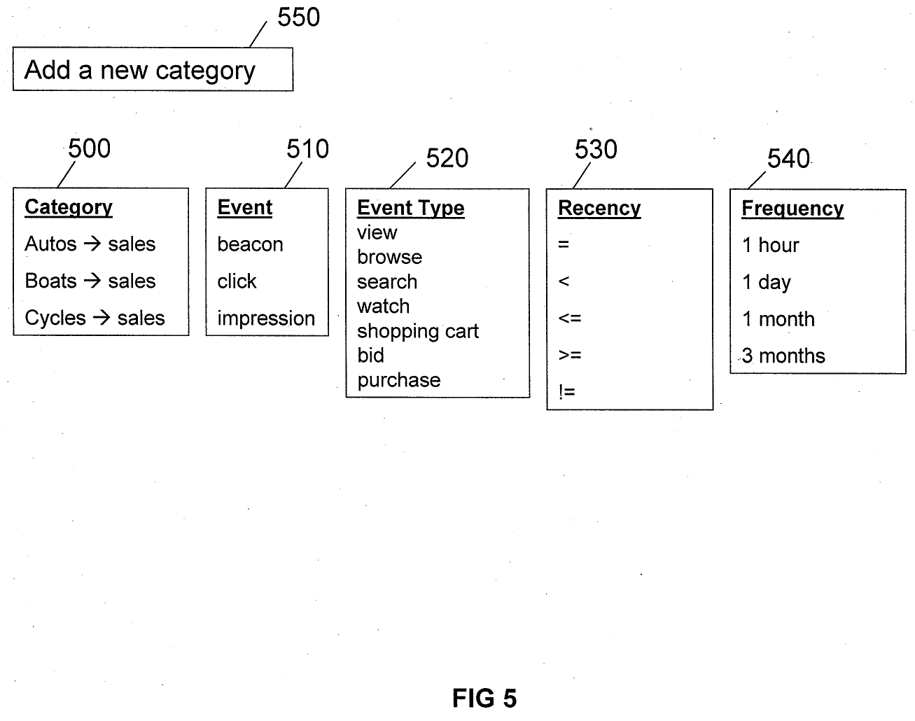

FIG. 5 is an example of a GUI for defining rules based on the selection of a specific category 500, event 510, event type 520, recency 530, and frequency 540. FIG. 5 shows the categories as auto, boat, and cycle sales. The category can be displayed in a variety of ways, for example, as a drop-down menu or drill down. The event 410 is the action associated with the publisher, e.g. beacon, click, impression. For example, if a certain combination occurs, the publisher serves an impression. A beacon is a notification sent to an advertiser when a certain event occurs, e.g. when a user buys an item.

The event type 520 signifies the action that the user performs. For example, if the cookie were tracking a user on the eBay® website, the event type is viewing an item, browsing in general, searching for a specific item, watching an item, bidding on the item, or purchasing the item. If the user is searching for items on the Amazon® website, the user might place the item in a shopping cart or purchase the item. Purchase is defined as the achievement of a pre-defined goal. Thus, purchase could be paying money for an item or a user submitting a telephone number or home address. Recency 530 connects the event type 520 with the frequency 540. For example, a publisher may want an impression served to all users that bid on an automobile in the last month.

In one embodiment, additional rules are generated by selecting the “add a category” button 550. These rules are connected using conventional Boolean terms. These rules constitute an ad campaign.

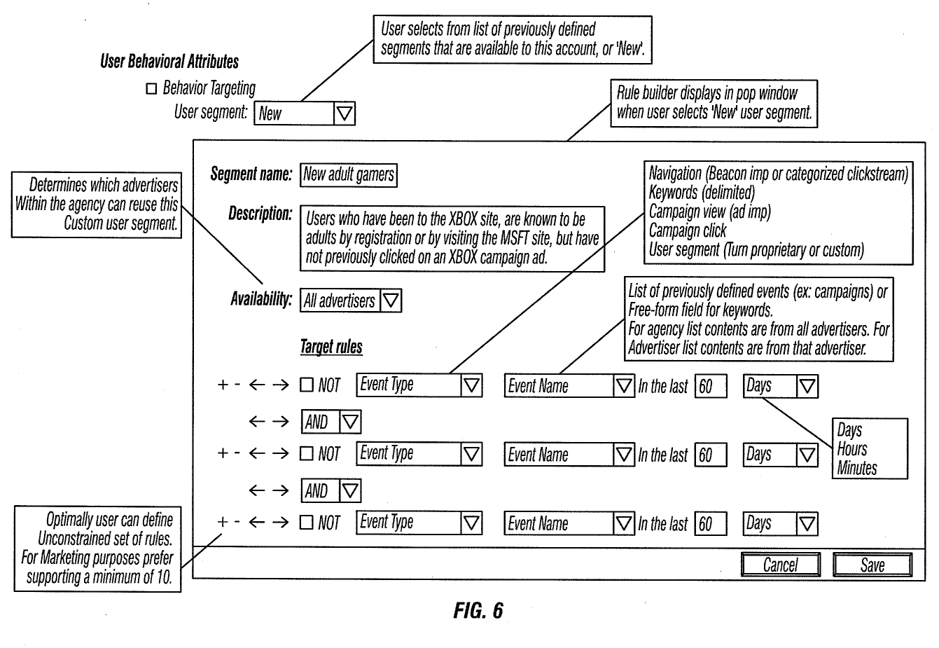

FIG. 6 is an illustration of a GUI for defining rules according to another embodiment of the invention. In this embodiment, the different rules can be combined. This model allows the user to define the segment name and include a description.

Feedback

When a publisher 130 designates a space on the web page for an advertisement, the space is associated with an ad code. If the ad space is large enough, it may even require multiple ad codes. Different websites with the same publisher receive different ad codes.

The ad codes are used to track the impressions served. A list is generated of the ad code, the impression, the time it was served, and the reaction, e.g. whether a user clicked on the ad. This is helpful for tracking users' reactions to the ads. Studies show that a user is more likely to purchase something when they see an advertisement for it multiple times on different websites. Tracking the impressions allows advertisers to present the ideal purchasing situation.

Impressions are also tracked to determine behavioral characteristics. For example, are people more likely to make discretionary purchases on the weekends, at work, etc. Furthermore, because the ad code is associated with a particular website, the user's visit to a particular website may help characterize the user's needs. For example, if the user is recorded visiting Kelly Blue Book, the user may be interested in purchasing a car. Behavioral characteristics can even include visiting patterns of an advertiser brand by an advertiser category. For example, with enough information, the system can predict that a user that buys clothing at the Gap® is likely to buy clothing at Old Navy® but not at Banana Republic®.

Lastly, impressions are tracked to prevent problems such as user fatigue. For example, a user may be less likely to make a purchase if the same ad is served more than four times in one day.

Displaying Advertisements

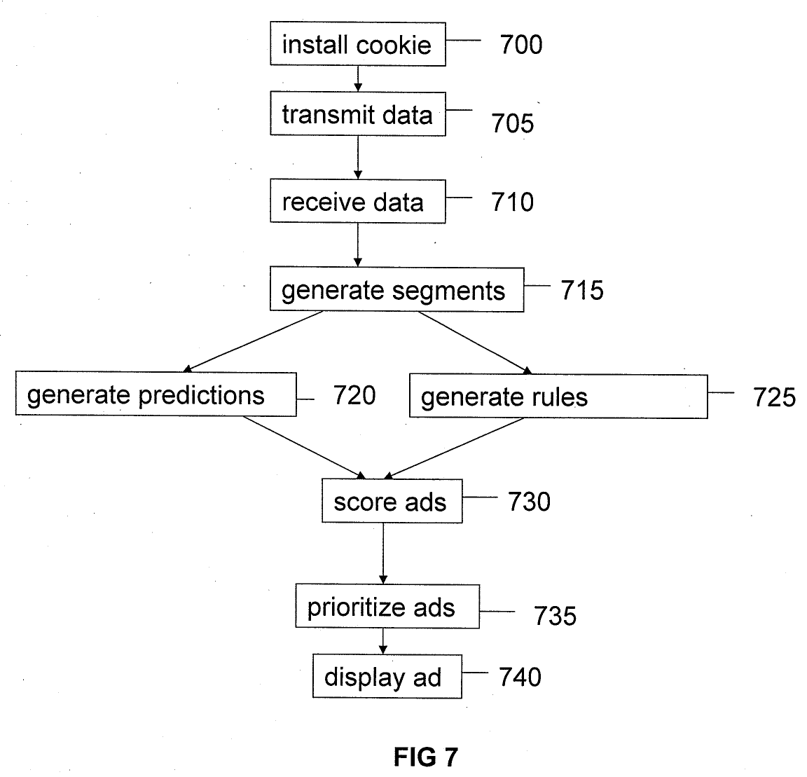

Now that the individual components have been described, it is possible to lay out the steps for generating segments according to the system illustrated in FIG. 2 and FIG. 4. These steps are illustrated in the flowchart of FIG. 7 according to one embodiment of the invention. FIG. 7 is an example of how the system functions during the initial runtime, i.e. when the system is still gathering information about users.

A cookie is installed 700 on the clients 100. The cookies transmit 705 data to a server 110. The data collection component 400 receives 710 data from the clients 100 and other sources. The segmentation component 410 generates 715 segments for all user data according to categories. In one embodiment, the modeling component 450 generates 720 predictions of user behavior. In another embodiment, the rule building component 420 generates 725 rules.

The ad scoring component 430 contains a database of ads 440. Each ad is associated with the price that the advertiser is willing to pay for displaying the ad and/or the click-through cost. The ads are scored 730 against either the predictive model or the rules, depending on the selected embodiment. If one advertiser has multiple ads selected for the same spot, the ads are prioritized 735 according to the ad score.

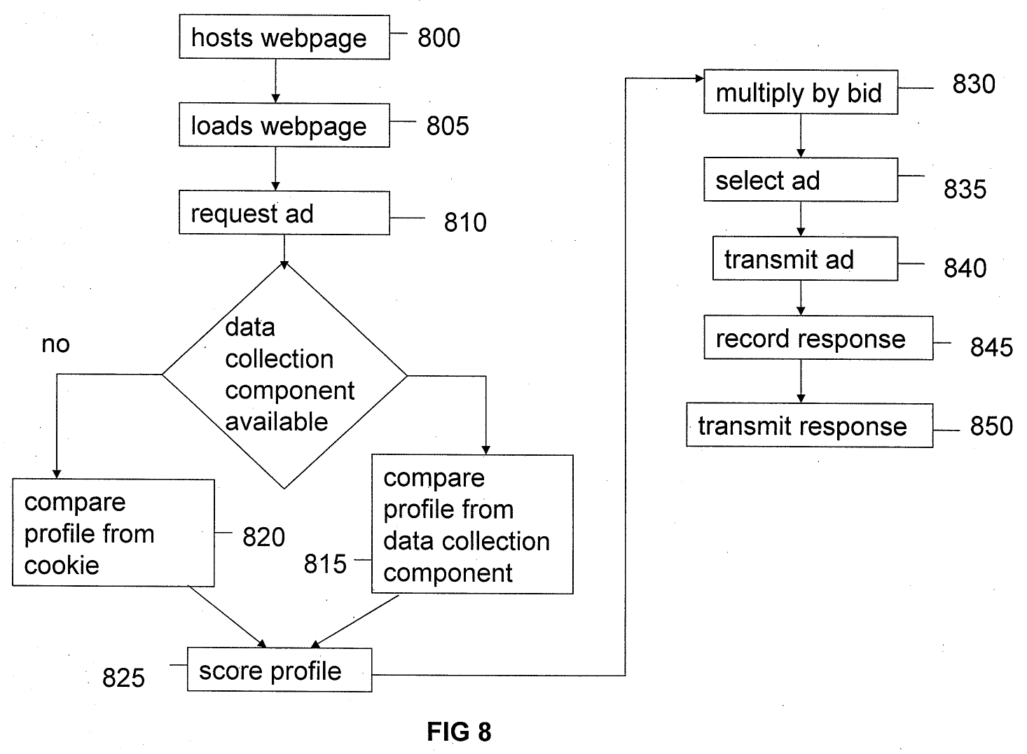

FIG. 8 is a flowchart depicting the steps implemented during runtime once the data collection component 400 contains sufficient information to support the models generated by the modeling component 450 according to one embodiment of the invention. A publisher 130 hosts 800 a web page with at least one ad space reserved for the system. A user loads 805 the web page. The browser requests 810 an ad call from the server 110 to transmit ads. The user profile from the data collection component 400 is compared 815 to the models. If the user profile from the data collection component 400 is unavailable, the user profile from the cookie is compared 820 to the model. This comparison is performed in real time. The ad scoring component 440 scores 825 the user profile against ads by multiplying 830 by the amount that each advertiser is willing to spend to display the advertisement times the ad score. The ad with the highest score*bid is selected 835 by the ad scoring component 430. The ad is transmitted 840 to the publisher 130 to serve to the client 100.

In one embodiment, the response is recorded 845 as part of the log file. In another embodiment, the response is recorded 845 directly in the cookie. The cookie transmits 850 the response to the server 110. The response is received by the data collection component 400 and used to further refine the segments. The feedback mechanism reinforces accurate predictions.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for scoring advertisements performed on at least one client, said client comprising a computer-readable medium coupled to a processor, the method comprising the steps of:
a data collection component storing data received from a plurality of clients, each client associated with a unique identifier, said data comprising a uniform resource locator (URL) for each website visited by said plurality of clients, a category for each item searched, viewed, or purchased on said website, and an action performed each time said client visits said website;
a segmentation component transforming said data into segments for each category and each action;
a modeling component generating models that group a plurality of said clients according to similarities in categories and actions performed by said clients;
a server receiving an ad call from a browser, said ad call associated with a client;
said modeling component comparing said client to said models to predict said client's similarity to said categories by comparing data associated with said client to said models;
an ad scoring component for generating an ad score for each of a plurality of advertisements based on said client's similarity to said model and a price that an advertiser pays for display of each advertisement;
selecting an advertisement from said plurality of advertisements with a highest ad score; and
said server transmitting to said browser said selected ad.

2. The method of claim 1, further comprising the step of:
receiving with said data collection component a notice of a click-through from said client in response to displaying said ad that is most likely to result in said click-through.

3. The method of claim 2, further comprising the step of:
receiving with said data collection component a notice of a conversion by said client in response to displaying said ad that is most likely to result in said click-through.

4. The method of claim 2, further comprising the step of:
updating said segments in response to receiving said notice of said click-through from said client in response to displaying said ad that is most likely to result in said click-through.

5. The method of claim 1, further comprising the step of:
wherein said step of retrieving a list of segments associated with said client is performed in real time.

6. The method of claim 1, further comprising the step of:
receiving said client's profile from a cookie stored on said client.

7. The method of claim 1, further comprising the step of:
multiplying said ad score by a price per impression.

8. The method of claim 1, wherein said data further comprises a profile for a user associated with said client, said profile comprising at least one of the following demographics: age, location, income, educational status, job category, and gender.

9. A system for scoring advertisements comprising:
a processor;
a storage device in communication with said processor and storing instructions adapted to be executed by said processor;
a data collection component that stores data received from a plurality of clients, each client associated with a unique identifier, said data comprising a uniform resource locator (URL) for each website visited by said plurality of clients, a category for each item searched, viewed, or purchased on said website, and an action performed each time said client visits said website;
a segmentation component that transforms said data into segments for each category and each action;
a modeling component that generates models that group a plurality of said clients according to similarities in categories and actions performed by said clients, said modeling component comparing a client to said models to predict said client's similarity to said categories by comparing data associated with said client to said models; and
an ad scoring component that generates an ad score for each of a plurality of advertisements based on said client's similarity to said model and a price that an advertiser pays for display of each advertisement, said ad scoring component selecting an advertisement from said plurality of advertisements with a highest ad score and transmitting said ad to a publisher in response to an ad call.

10. The method of claim 9, further comprising the step of:
multiplying said ad score by a price per impression.

11. The method of claim 9, further comprising the step of:
charging an advertiser that provided said ad that is most likely to result in said click-through for transmitting said ad.

12. The method of claim 9, further comprising the step of:
embedding a beacon in said browser, said beacon comprising at least one rule defined by an advertiser; and
notifying said advertiser when said client performs actions that are covered by said at least one rule.

13. The method of claim 9, further comprising the step of:
receiving with said data collection component a notice of said click-through from said client in response to displaying said ad that is most likely to result in said click-through.

14. The method of claim 13, further comprising the step of:
updating said segments in response to receiving said notice of a click-through from said client in response to displaying said ad that is most likely to result in said click-through.

15. A system for predicting user behavior in response to an advertisement comprising:
a data collection component stored on at least one computer, said computer comprising a computer-readable medium coupled to a processor, said data collection component for receiving data from a plurality of clients, each client associated with a unique identifier, said data comprising a uniform resource locator (URL) for each website visited by said plurality of clients, a category for each item searched, viewed, or purchased on said website, and an action performed each time said client visits said website;
a segmentation component coupled to said data collection component, said segmentation component adapted to receive said data from said data collection component and transforming said data into segments and grouping said clients according to said segments;
a modeling component coupled to said data collection component and said segmentation component, said modeling component receiving said segments from said segmentation component and generating models to predict a user's reaction to display of an advertisement on said client;
a rule building component coupled to said segmentation component, said rule building component for generating a series of rules for displaying advertisements on a website, said rules organized by a category, an event, an event type, a recency, and a frequency; and
an ad scoring component coupled to said modeling component, said segmentation component, and said rule building component, said ad scoring component receiving a prediction from said modeling component and scoring a plurality of ads by comparing said ads that satisfy said rules generated by said rule building component to determine an ad that is most likely to result in a click-through.

16. The system of claim 15, wherein said system comprises a distributed datastore environment.

17. The system of claim 15, wherein said ad scoring component further comprises a database for storing said plurality of ads.

18. The system of claim 15, wherein said data received by said data collection component is derived from a cookie stored on said client.

19. The system of claim 15, wherein said modeling component predicts actions for said client by comparing said client to actions of other clients grouped according to said segments.

20. The system of claim 15, wherein said data is received from a third-party server that collects data from a plurality of cookies stores on said clients.
